(19) United States
(12) Patent Application Publication
(10) Pub. No.: US 2020/0164272 A1
(43) Pub. Date: May 28, 2020

(54) VIDEO GAME PROCESSING PROGRAM AND VIDEO GAME PROCESSING SYSTEM

(71) Applicant: SQUARE ENIX CO., LTD., Tokyo (JP)

(72) Inventors: Shunsuke INABA, Tokyo (JP); Takuya SHIOMI, Tokyo (JP)

(73) Assignee: SQUARE ENIX CO., LTD., Tokyo (JP)

(21) Appl. No.: 16/618,562

(22) PCT Filed: Jun. 6, 2017
(86) PCT No.: PCT/JP2017/021010

§ 371 Date: Dec. 2, 2019

(51) Int. Cl. A63F 13/44; A63F 13/533; A63F 13/35

(52) U.S. Cl. CPC A63F 13/44; A63F 13/35; A63F 13/533

(57) ABSTRACT

A method of using an in-game element is caused to have variations to improve interest in a video game.

One timing UI corresponding to an in-game element that is set to an operation target of a user among plural kinds of user interfaces (timing UIs) for evaluating operation timing of a user is displayed. The timing UI may be displayed in a case where an action condition for the operation target is satisfied. It may be configured so that evaluation is accumulated, and a specific process is executed in a case where an accumulation state of evaluation satisfies a predetermined condition.

### BACKGROUND ART

Heretofore, in a field of a video game, various kinds of systems for changing a feature of an operation target of a user (or a player) by setting a so-called item to the operation target, for example, by causing a character to equipment have been proposed.

In such systems, there is one in which appearance of a character changes in accordance with a type of worn equipment and a change generated on a mental state of a character in accordance with the type of worn equipment is expressed (see Patent Document 1).

### PRIOR ART DOCUMENTS

### Patent Documents

Patent Document 1: Japanese Patent Application Publication No. 2000-113206

### SUMMARY OF THE INVENTION

### Problems to be Solved by the Invention

However, a large number of systems in each of which appearance of a character changes in accordance with equipment have been proposed. Thus, there has been a problem that even though such a system is provided to a user, it may not become a factor that improves interest in a video game. Namely, a new method of using an item or the like set to an operation target in a video game (hereinafter, referred to as an “in-game element”) has been found.

It is an object of at least one of embodiments according to the present invention to solve the problem described above, and cause a method of using an in-game element to have variations to improve interest in a video game.

### Means for Solving the Problems

According to a non-limiting aspect of the present invention, a video game processing program according to one embodiment of the present invention is a video game processing program for causing a server to realize functions to control progress of a video game in response to an operation of a user. The functions include: a setting function configured to set an in-game element to an operation target of the user, a user interface for evaluating operation timing by the user (hereinafter, referred to as a “timing UI”) being associated with the in-game element; a display function configured to cause a terminal to display a game screen on a display screen of the terminal in a case where an action condition for the operation target is satisfied, the game screen containing the timing UI corresponding to the set in-game element among plural kinds of timing UIs; an evaluating function configured to evaluate a user operation via the game screen on a basis of an evaluation rule corresponding to the timing UI; and an executing function configured to execute a process corresponding to the evaluation.

According to another non-limiting aspect of the present invention, a video game processing system according to one embodiment of the present invention is a video game processing system including a communication network, a server, and a user terminal, the video game processing system configured to control progress of a video game in response to an operation of a user. the video game processing system includes: a setting unit configured to set an in-game element to an operation target of the user, a user interface for evaluating operation timing by the user (hereinafter, referred to as a “timing UI”) being associated with the in-game element; a display unit configured to cause a terminal to display a game screen on a display screen of the terminal in a case where an action condition for the operation target is satisfied, the game screen containing the timing UI corresponding to the set in-game element among plural kinds of timing UIs; an evaluating unit configured to evaluate a user operation via the game screen on a basis of an evaluation rule corresponding to the timing UI; and an executing unit configured to execute a process corresponding to the evaluation.

According to still another non-limiting aspect of the present invention, a video game processing program according to one embodiment of the present invention is a video game processing program for causing a user terminal to realize functions to control progress of a video game in response to an operation of a user. The functions include: a setting function configured to set an in-game element to an operation target of the user, a user interface for evaluating operation timing by the user (hereinafter, referred to as a “timing UI”) being associated with the in-game element; a display function configured to cause the user terminal to display a game screen in a case where an action condition for the operation target is satisfied, the game screen containing the timing UI corresponding to the set in-game element among plural kinds of timing UIs; an evaluating function configured to evaluate a user operation via the game screen on a basis of an evaluation rule corresponding to the timing UI; and an executing function configured to execute a process corresponding to the evaluation.

### Effects of the Invention

According to each of the embodiments of the present application, one or two or more shortages are solved.

### BRIEF DESCRIPTION OF THE DRAWINGS

FIG. 1 is a block diagram illustrating an example of a configuration of a video game processing system corresponding to at least one of the embodiments according to the present invention.

FIG. 2 is a block diagram illustrating a configuration of a server corresponding to at least one of the embodiments according to the present invention.

FIG. 3 is a flowchart illustrating an example of game processing corresponding to at least one of the embodiments according to the present invention.

FIG. 4 is a flowchart illustrating an example of an operation at a server side in the game processing corresponding to at least one of the embodiments according to the present invention.

FIG. 5 is a flowchart illustrating an example of an operation of a terminal side in the game processing corresponding to at least one of the embodiments according to the present invention.

FIG. 6 is a block diagram illustrating a configuration of a server corresponding to at least one of the embodiments according to the present invention.

FIG. 7 is a flowchart illustrating an example of game processing corresponding to at least one of the embodiments according to the present invention.

FIG. 8 is a block diagram illustrating a configuration of a server corresponding to at least one of the embodiments according to the present invention.

FIG. 9 is a flowchart illustrating an example of game processing corresponding to at least one of the embodiments according to the present invention.

FIG. 10 is a block diagram illustrating a configuration of a server corresponding to at least one of the embodiments according to the present invention.

FIG. 11 is a flowchart illustrating an example of game processing corresponding to at least one of the embodiments according to the present invention.

FIG. 12 is a block diagram illustrating a configuration of a server corresponding to at least one of the embodiments according to the present invention.

FIG. 13 is a flowchart illustrating an example of game processing corresponding to at least one of the embodiments according to the present invention.

FIG. 14 is a block diagram illustrating a configuration of a server corresponding to at least one of the embodiments according to the present invention.

FIG. 15 is an explanatory drawing for explaining an example of a storage state of information corresponding to at least one of the embodiments according to the present invention.

FIG. 16 is a flowchart illustrating an example of the game processing corresponding to at least one of the embodiments according to the present invention.

FIG. 17 is an explanatory drawing for explaining an example of a game screen corresponding to at least one of the embodiments according to the present invention.

FIG. 18 is an explanatory drawing for explaining an example of a timing UI corresponding to at least one of the embodiments according to the present invention.

FIG. 19 is an explanatory drawing for explaining an example of the timing UI corresponding to at least one of the embodiments according to the present invention.

### DESCRIPTION OF THE EMBODIMENTS

Hereinafter, examples of embodiments according to the present invention will be described with reference to the drawings. In this regard, various kinds of elements in an example of each embodiment, which will be described below, can appropriately be combined with each other in a range where contradiction or the like did not occur. Further, explanation of the content that will be described as an example of an embodiment may be omitted in another embodiment. Further, the content of operations and/or processing with no relation to characteristic portions of each embodiment may be omitted. Moreover, various kinds of processing that constitute various kinds of processing flows (will be described below) may be carried out in random order in a range where contradiction or the like did not occur in the content of the processing.

### First Embodiment

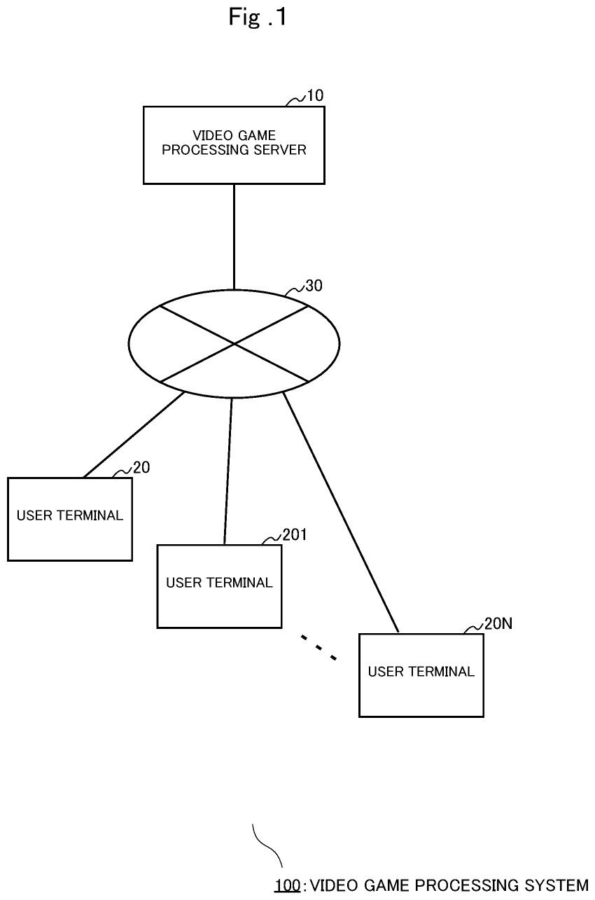

FIG. 1 is a block diagram illustrating an example of a configuration of a video game processing system 100 according to one embodiment of the present invention. As illustrated in FIG. 1, the video game processing system 100 includes a video game processing server 10 (hereinafter, referred to as a “server 10”) and a plurality of user terminals 20 and 201 to 20N (“N” is an arbitrary integer), each of which is used by a user of the video game processing system. In this regard, a configuration of the video game processing system 100 is not limited to this configuration. The video game processing system 100 may be configured so that a plurality of users uses a single user terminal, or may be configured so as to include a plurality of servers.

Each of the server 10 and the plurality of user terminals 20 and 201 to 20N is connected to a communication network 30 such as the Internet. In this regard, although it is not illustrated in the drawings, the plurality of user terminals 20 and 201 to 20N is connected to the communication network 30 by carrying out data communication with base stations managed by a telecommunication carrier by means of a radio communication line.

The video game processing system 100 includes the server 10 and the plurality of user terminals 20, 201 to 20N, whereby various kinds of functions for carrying out various kinds of processes in response to an operation of the user are realized.

The server 10 includes a function to control progress of a video game in response to an operation of a user. In the present embodiment, the server 10 is managed by an administrator of the video game processing system 100, and has various kinds of functions to provide information regarding the various kinds of processes to the plurality of user terminals 20, 201 to 20N. Further, the server 10 the server 10 is constructed by an information processing apparatus, such as a WWW server, and includes a storage medium for storing various kinds of information. In this regard, the server 10 is provided with a general configuration for carrying out the various kinds of processes, such as a control section and a communicating section, as a computer. However, its explanation herein is omitted. Further, in the video game processing system 100, it is preferable that the server 10 manages various kinds of information from a point of view to reduce a processing load on each of the plurality of user terminals 20, 201 to 20N. However, a storage unit configured to store various kinds of information may include a storage area in a state where the server 10 can access the storage region. For example, the server 10 may be configured so as to be provided with a dedicated storage region outside the server 10.

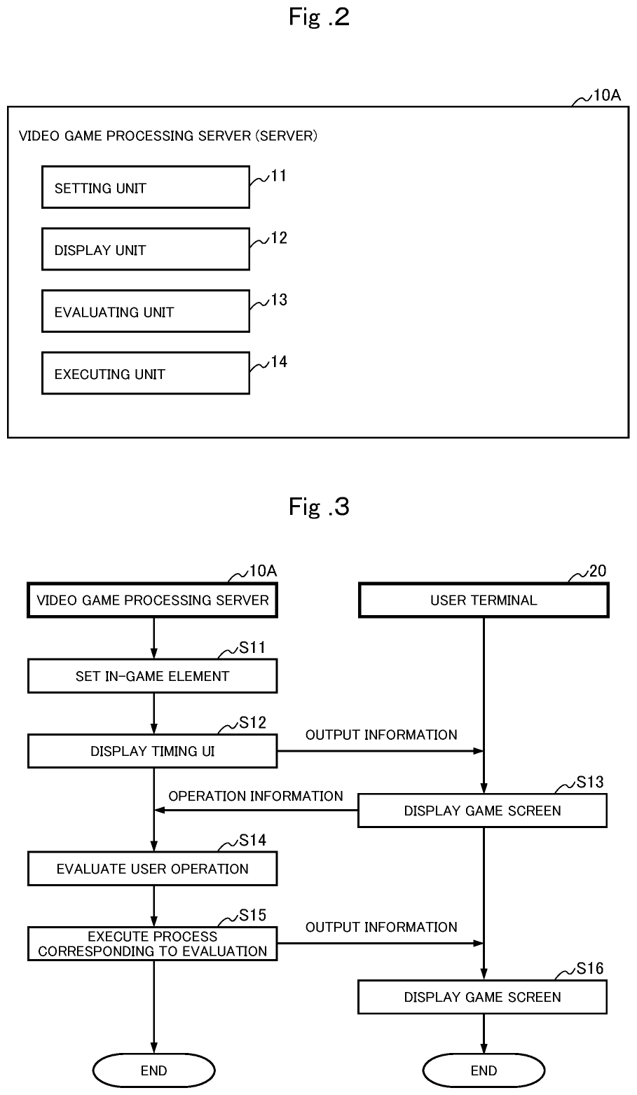

FIG. 2 is a block diagram a configuration of a video game processing server 10A (hereinafter, referred to as a “server 10A”), which is an example of the video game processing server 10. As illustrated in FIG. 2, the server 10A at least includes a setting unit 11, a display unit 12, an evaluating unit 13, and an executing unit 14.

The setting unit 11 has a function to set an in-game element to an operation target of the user. A user interface (hereinafter, referred to as a “timing UI”) for evaluating operation timing by the user is associated with the in-game element.

Here, the word “operation target” means a target that act or operate in response to a user operation in the video game. The configuration of the operation target is not limited particularly so long as the user is allowed to recognize the operation target. As examples of the operation target, there are a user in FPS, and a character or an avatar in TPS.

Further, the configuration for evaluating operation timing by the user is not limited particularly. However, it is preferable that the configuration is a configuration in which the user is allowed to recognize start of evaluation and end of the evaluate. As an example of such a configuration, there is one in which a marker for showing the user the operation timing (an operation marker) moves in accordance with a lapse of time.

Further, the configuration of a user interface is not limited particularly. However, it is preferable that a user who views a game screen easily recognize when and what kind of operation input the user may carry out. Namely, it is preferable that the user interface according to the present embodiment is configured so that the user interface can be recognized to be a GUI (Graphical User Interface). However, it may be configured so that the user is encouraged to carry out an operation by any other element, for example, sound.

Further, the word “in-game element” means an element that the user can use in the video game. As an example of the in-game element, there is a so-called item.

Further, the configuration to set an in-game element to an operation target is not limited particularly. However, it is preferable that the configuration is one in which an intention of the user is reflected. As an example of such a configuration, there is a configuration in which an in-game element selected by the user is associated with identification information of the operation target. In this regard, like so-called equipment, it may be configured so that appearance or a parameter of the operation target changes in accordance with the set operation target. Further, it may be configured so that in a case where a predetermined condition is satisfied in accordance with a progress status of the video game, for example, an in-game element associated with the predetermined condition is set to the operation target regardless of a user operation.

The display unit 12 has a function to display a game screen on a display screen of a terminal in a case where an action condition for the operation target is satisfied. The game screen contains a timing UI corresponding to the in-game element set from plural kinds of timing UIs.

Here, the word “action condition” means a condition that an action against an operation target is allowed in the video game or a virtual space. An example of the action condition is not limited particularly. However, it is preferable that the user is allowed to recognize the content thereof. As an example of the action condition, there is one that it becomes an own turn in a so-called turn-based battle.

Further, the word “plural kinds of timing UIs” means timing UIs in which the user is allowed to recognize a difference in types of the timing UIs at least when they are displayed on the game screen. As an example of the plural kinds of timing UIs, there is one behavior or appearance is different among different kinds. Here, it is preferable that a difference in behavior influences on the degree of difficulty of an operation. As an example of the difference in the behavior, there is a difference in a movement speed of an operation marker. Further, it is preferable that the difference in appearance thereof is such a degree that the user is allowed to at least recognize the difference.

Further, the phrase “cause the display device to display an image on the display screen” means causing each of the user terminals 20, 201 to 20N to output an image on the display device included therein by means of communication using the communication network 30. As an example of the configuration to cause the display device to display an image, there is a configuration in which information (image information) generated at a server side is transmitted to each side of the user terminals 20, 201 to 20N. In this regard, the configuration of the image information is not limited particularly. For example, the image information may be information in which an image is compressed, or information for causing each side of the user terminals 20, 201 to 20N to generate an image. As an example of the information in which an image is compressed, there is one used in a cloud game (for example, MPEG). Further, as an example of the information for causing each side of the user terminals 20, 201 to 20N to generate an image, there is one used in an online game.

The evaluating unit 13 has a function to evaluate a user operation via the game screen on the basis of an evaluation rule corresponding to a timing UI.

Here, the phrase “a user operation via the game screen” means a user operation corresponding to a status of video game displayed on the game screen. In other words, it means a user operation against the timing UI.

Further, the configuration of the evaluation rule is not limited particularly so long as the user operation can be evaluated by the evaluation rule. As an example of the evaluation rule, there is one in which user operations are classified into a predetermined number of steps in accordance with a status when it is received.

The executing unit 14 has a function to execute a process corresponding to evaluation.

Here, the configuration of a process corresponding to evaluation is not limited particularly. However, it is preferable that it is a configuration in which a process advantageous to the user is executed as evaluation is better evaluation. As an example of such a configuration, there is a configuration that a process, in which with respect to an action carried out by an operation target in case of middle evaluation of three steps of evaluation, an additional effect is generated in case of the highest evaluation, and an advantageous effect to an enemy is generated in case of the lowest evaluation, is executed.

Each of the plurality of user terminals 20, 201 to 20N is managed by a user, and is configured by a communication terminal, such as a cellular phone terminal, a PDA (Personal Digital Assistants), a mobile game device, and a so-called wearable divide, by which the user can play a network delivery type video game, for example. In this regard, a configuration of the user terminal that the video game processing system 100 can include is not limited to the examples described above. It may be a configuration in which the user is allowed to recognize the video game. As other examples of the user terminal, there are a combination of various kinds of communication terminals, a personal computer, and a stationary game device.

Further, each of the plurality of user terminals 20, and 201 to 20N is connected to the communication network 30, and includes hardware (for example, a display device for displaying a browser screen according to a coordinate or a game screen) and software for carrying out various kinds of processing by communicating with the server 10. In this regard, each of the plurality of user terminals 20, 201 to 20N may be configured so as to be capable of directly communicating with each other without the server 10.

Next, an operation of the video game processing system 100 (hereinafter, referred to simply as a “system 100”) according to the present embodiment will be described.

FIG. 3 is a flowchart illustrating an example of game processing executed by the system 100. In the game processing according to the present embodiment, processing related to the timing UI is executed. Hereinafter, a case where the server 10A and the user terminal 20 (hereinafter, referred to as a “terminal 20”) execute the game processing will be described as an example.

For example, the game processing is started in a case where a setting condition for the in-game element in the video game is satisfied. Hereinafter, a case where the setting condition for the in-game element is satisfied by an operation of the user who operates the terminal 20 will be described as an example.

In the game processing, the server 10A first sets an in-game element to an operation target (Step S11). In the present embodiment, the server 10A sets an in-game element selected by the user to a predetermined operation target or an operation target selected by the user.

When the in-game element is set, the server 10A displays a timing UI (Step S12). In the present embodiment, in a case where an action condition of the operation target is satisfied, the server 10A generates information for outputting a game screen, which contains the timing UI corresponding to the in-game element set to the operation target, to the display screen of the display device included in the terminal 20 (hereinafter, referred to as “output information”), and transmits the generated output information to the terminal 20.

The terminal 20 displays the game screen on the display screen in the display device included therein on the basis of the output information received from the server 10A (Step S13), and transmits information regarding an operation received from the user (hereinafter, referred to as “operation information”) to the server 10A.

When the operation information is received from the terminal 20, the server 10A evaluates a user operation (Step S14). In the present embodiment, the server 10A evaluates the user operation by using the received operation information and the evaluation rule.

When the user operation is evaluated, the server 10A execute a process corresponding to the evaluation (Step S15). In the present embodiment, the server 10A transmits output information for informing the user that the process corresponding to the evaluation is executed to the terminal 20.

The terminal 20 causes the display device included therein to display a game screen on the display screen on the basis of the output information received from the server 10A (Step S16), and terminates the processing herein.

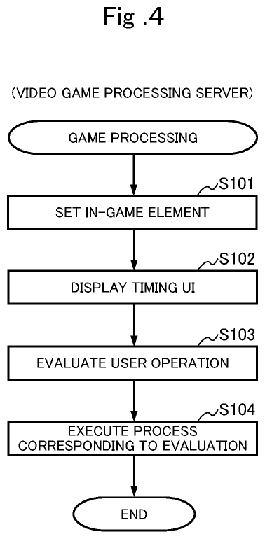

FIG. 4 is a flowchart illustrating an example of an operation of the server 10A side in the game processing. Here, an operation of the server 10A in the system 100 will be described again.

In the game processing, the server 10A first sets an operation target to an in-game element (Step S101); displays a timing UI corresponding to the set in-game element (Step S102); evaluates a user operation (Step S103); and executes the process corresponding to the evaluation (Step S104).

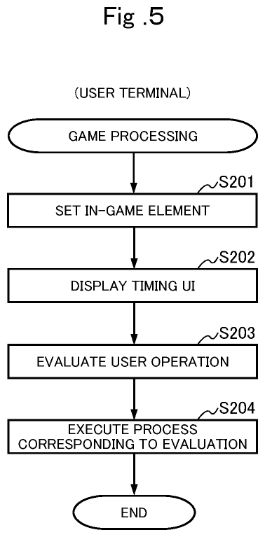

FIG. 5 is a flowchart showing an example of an operation of the terminal 20 side in a case where the terminal 20 carries out the game processing. Hereinafter, the case where the terminal 20 carries out the game processing by a single body will be described as an example. In this regard, a configuration of the terminal 20 includes similar functions to the configuration of the server 10 except that the terminal 20 receives various kinds of information from the server 10. For this reason, its description is omitted from a point of view to avoid repeated explanation.

In the game processing, the terminal 20 first sets an in-game element to an operation target (Step S201); displays a timing UI corresponding to the set in-game element (Step S202); evaluates a user operation (Step S203); and executes a process corresponding to the evaluation (Step S204). In the present embodiment, the terminal 20 obtains the information used in each Step by communicating with the server 10A. In this regard, the terminal 20 may be configured so as to specify the information used in each Step by referring to a storage unit included therein.

As explained above, as one side of the first embodiment, the server 10A provided with the functions to control progress of the video game in response to an operation of the user is configured so as to include the setting unit 11, the display unit 12, the evaluating unit 13, and the executing unit 14. Thus, the setting unit 11 sets the in-game element, with which the user interface for evaluating the operation timing by the user is associated, (the timing UI) to the operation target of the user; the display unit 12 displays the game screen, which contains the timing UI corresponding to the set in-game element among the plural kinds of timing UIs, on the display screen of the terminal in a case where the action condition for the operation target is satisfied; the evaluating unit 13 evaluates the user operation via the game screen on the basis of the evaluation rule corresponding to the timing UI; and the executing unit 14 executes the process corresponding to the evaluation. Therefore, it is possible to cause a method of using the in-game element to have variations to improve interest in the video game.

Namely, not only appearance of the character but also appearance of the UI change in accordance with the in-game element set to the operation target. Therefore, for example, it is possible to cause the method of using the in-game element to have variations compared with a configuration in which only appearance of the character changes.

### Second Embodiment

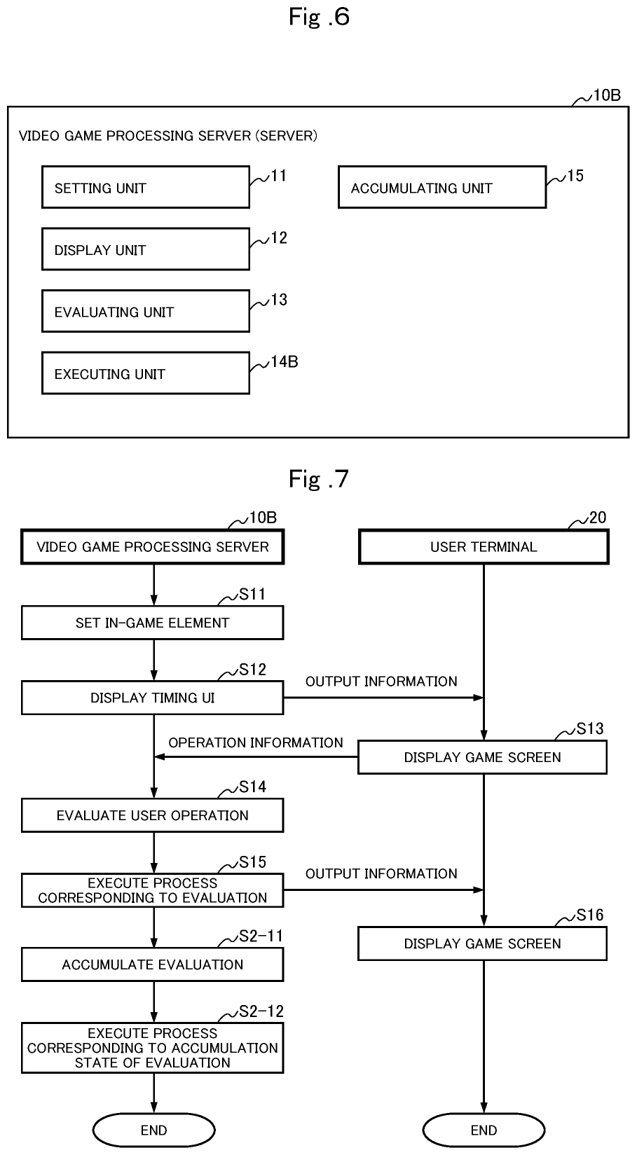

FIG. 6 is a block diagram illustrating a configuration of a video game processing server 10B (hereinafter, referred to as a “server 10B”), which is an example of the video game processing server 10. In the present embodiment, the server 10B at least includes a setting unit 1, a display unit 12, an evaluating unit 13, an executing unit 14B, and an accumulating unit 15.

The accumulating unit 15 has a function to accumulate evaluation by the evaluating unit 13.

Here, the phrase “accumulate evaluation” means that evaluation in multiple times (or evaluation results) is saved in a state that the user can refer to it. The configuration to accumulate evaluation is not limited particularly. However, it is preferable that it may be configured so that the user can refer to order of the evaluation that was executed multiple times.

The executing unit 14B has a function to execute, in a case where an accumulation state of the evaluation satisfies a predetermined condition, a process corresponding to the predetermined condition in addition to a process corresponding to the evaluation.

Here, the content of the condition regarding the accumulation state of the evaluation is not limited particularly. However, it is preferable that it is configured so that a process to be executed becomes more valuable for the user as the content is thought to be difficult for the user to realize it.

Further, the content of the process corresponding to the predetermined condition is not limited particularly. The content may be the content independently from the process corresponding to the evaluation, or may be the content related thereto.

FIG. 7 is a flowchart illustrating an example of game processing executed by the system 100. Hereinafter, operations of the server 10B and the terminal 20 will be described as an example. In this regard, description of a flowchart for illustrating an operation of each of the server 10B and the terminal 20 is omitted from a point of view to avoid repeated explanation.

When a process corresponding to evaluation is executed, the server 10B accumulates the evaluation (Step S2-11). In the present embodiment, the server 10B saves the evaluation this time in a predetermined storage region as evaluation of the user of the terminal 20.

When the evaluation is accumulated, the server 10B executes a process corresponding to the accumulation state of the evaluation (Step S2-12). In the present embodiment, in a case where the accumulation state of the evaluation for a predetermined period satisfies a predetermined condition, the server 10B executes a predetermined process.

As explained above, as one side of the second embodiment, the user terminal 20B is configured so as to include the setting unit 11, the display unit 12, the evaluating unit 13, the executing unit 14B, and the accumulating unit 15. Thus, the accumulating unit 15 accumulates the evaluation regarding the user operation, and the executing unit 14B executes the process corresponding to the predetermined condition in addition to the process corresponding to the evaluation in a case where the accumulation state of the evaluation satisfies the predetermined condition. Therefore, it is possible to improve interest in user evaluation against the timing UI that changes in accordance with the in-game element set to the operation target.

Namely, not only the process for the evaluation against each operation is executed, but also another process can be executed in accordance with the evaluation against the operation in multiple times. Therefore, it is possible to increase an influence on the user by a change in the timing UI.

### Third Embodiment

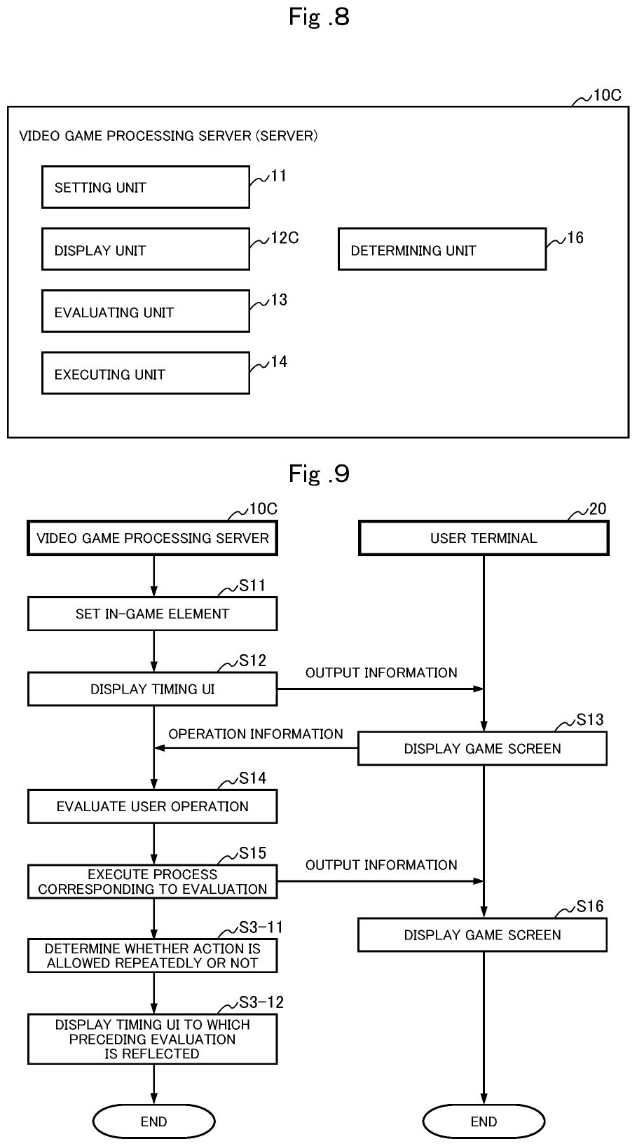

FIG. 8 is a block diagram illustrating a configuration of a video game processing server 10C (hereinafter, referred to as a “server 10C”), which is an example of the video game processing server 10. In the present embodiment, the server 10C at least includes a setting unit 11, a display unit 12C, an evaluating unit 13, an executing unit 14, and a determining unit 16.

The determining unit 16 has a function to determine whether an action against an operation target is allowed repeatedly in the same turn or not on the basis of a predetermined determination rule in a case where a user operation is evaluated in a turn-based battle using the operation target.

Here, the word “turn-based battle” means a battle in which in principle a player inputs an instruction against the operation target in each turn. Further, the phrase “an action is allowed repeatedly in the same turn” means that the player is allowed to input an instruction against the operation target again after the player inputted the instruction against the operation target and before it becomes a turn of an enemy. The configuration to determine whether an action is allowed repeatedly or not is not limited particularly. However, it is preferable that the player is allowed to grasp the determination rule. As an example of such a configuration, there is a configuration in which the player is allowed to input an instruction against the operation target until a predetermined value (for example, a value that is consumed when the operation target acts) becomes a threshold value or lower.

The display unit 12C has a function to display a timing UI to which at least preceding evaluation is reflected in a case where it is determined, by the determining unit 16, that an action against the operation target is allowed repeatedly in the same turn. In this regard, a configuration in a case where it is determined, by the determining unit 16, that an action against the operation target is allowed repeatedly in the same turn is not limited particularly. However, it is preferable that it is a configuration in which it becomes a turn to allow one other than an operation target of the user to operate.

Here, the word “preceding evaluation” means evaluation for a user operation. Further, the configuration to reflect evaluation to the timing UI is not limited particularly. For example, it may be configured so that plural kinds of evaluation against the user operation before the predetermined number of times is reflected to the timing UI. Further, a relation between the evaluation and the timing UI is not limited particularly. However, it is preferable that it is a relationship in which the user is allowed to recognize the reflected evaluation. As an example of such a relationship, there is a configuration in which a portion that indicates evaluation is contained in appearance of a timing UI.

FIG. 9 is a flowchart illustrating an example of game processing executed by the system 100. Hereinafter, operations of the server 10C and the terminal 20 will be described as an example. In this regard, description of a flowchart for illustrating an operation of each of the server 10C and the terminal 20 is omitted from a point of view to avoid repeated explanation.

When the process corresponding to the evaluation is executed, the server 10C determines whether an action is allowed repeatedly or not (Step S3-11). In the present embodiment, the server 10C determines that the action against an operation target is allowed repeatedly in a case where a value obtained by subtracting a value corresponding to a user operation thus received from the predetermined value is the threshold value or more. On the other hand, in a case where the predetermined value becomes lower than the threshold value, the server 10C determines that the action against the operation target is not allowed repeatedly.

In a case where it is determined that the action is allowed repeatedly, the server 10C displays a timing UI to which preceding evaluation is reflected (Step S3-12). In this regard, in the present embodiment, in a case where it is determined that the action is not allowed repeatedly, the server 10C causes a status of a video game to shift to a turn of an opponent.

As explained above, as one side of the third embodiment, the user terminal 20C is configured so as to include the setting unit 11, the display unit 12C, the evaluating unit 13, the executing unit 14, and the determining unit 16. Thus, the determining unit 16 determines whether the action against the operation target is allowed repeatedly in the same turn or not on the basis of the predetermined determination rule in a case where the user operation is evaluated in the turn-based battle using the operation target, and the display unit 12C displays the timing UI to which at least the preceding evaluation is reflected in a case where it is determined that the action is allowed repeatedly. Therefore, it is possible to use the timing UI that changes by setting the in-game element to the turn-based battle.

In this regard, it has not been mentioned particularly in the example of the third embodiment. However, the server 10C may be configured so as to execute a predetermined process before termination of the turn in a case where the evaluation of the user operation against the operation target satisfies a predetermined condition in one turn by the predetermined number of times. By configuring the server 10C in this manner, it is possible to increase an influence on each turn by the evaluation of the user operation, and this makes it possible to improve interest in the video game.

### Fourth Embodiment

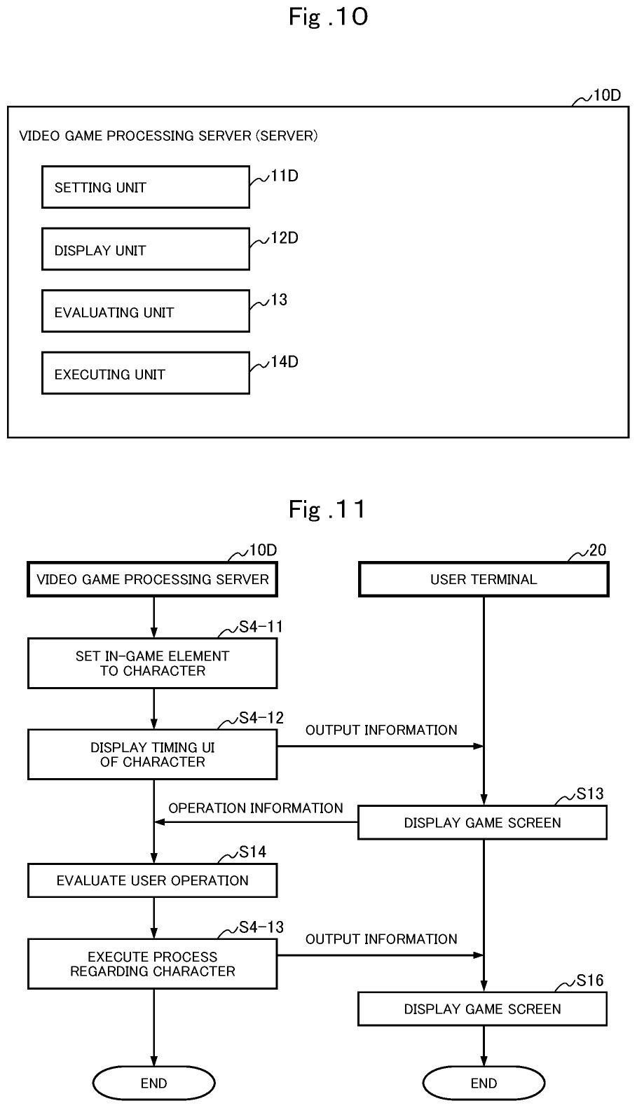

FIG. 10 is a block diagram illustrating a configuration of a video game processing server 10D (hereinafter, referred to as a “server 10D”), which is an example of the video game processing server 10. In the present embodiment, the server 10D at least includes a setting unit 11D, a display unit 12D, an evaluating unit 13, and an executing unit 14D.

The setting unit 11D has a function to set an in-game element to each of a plurality of characters as an operation target of a user.

Here, the configuration to set the in-game element to each of the plurality of characters is not limited particularly. However, it is preferable that it is a configuration in which an in-game element corresponding to a different timing UI may be set to each character.

The display unit 12D has a function to display a game screen, which contains a timing UI corresponding to the in-game element set to the character in a case where an action condition for the character selected by the user from the plurality of characters is satisfied.

Here, the content of the action condition is not limited particularly. However, it is preferable that the content that an action condition for one character can be satisfied consecutively is contained in the content.

The executing unit 14D has a function to execute a process regarding the character as at least a part of a process corresponding to the evaluation.

Here, the content of the process regarding the character is not limited particularly. The content may be a process that influences on the own character, or may be a process that influences on another character. As examples of such a process, there are recovery of a status and an attack.

FIG. 11 is a flowchart illustrating an example of game processing executed by the system 100. Hereinafter, operations of the server 10D and a terminal 20 will be described as an example. In this regard, description of a flowchart for illustrating an operation of each of the server 10D and the terminal 20 is omitted from a point of view to avoid repeated explanation.

In the game processing, the server 10D first sets an in-game element to a character as an operation target (Step S4-11). In the present embodiment, the server 10D sets an in-game element, which the user obtains in accordance with progress of a video game, to the character owned by the user in response to a user operation. Further, the server 10D updates the information regarding the character on the basis of information regarding the set in-game element.

When the in-game element is set to the character, the server 10D displays a timing UI of the character (Step S4-12). In the present embodiment, the server 10D causes the terminal to display a game screen that contains a timing UI corresponding to the in-game element set to the character for which an action condition is satisfied.

When the user operation is evaluated on the basis of operation information received from the terminal 20, the server 10D executes a process regarding the character (Step S4-13). In the present embodiment, the server 10D transmits output information for informing the user that the process regarding the character is executed to the terminal 20.

As explained above, as one side of the fourth embodiment, the server 10D is configured so as to include the setting unit 11D, the display unit 12D, the evaluating unit 13, and the executing unit 14D. Thus, the setting unit 11D sets the in-game element to each of the plurality of characters as the operation target of the user; the display unit 12D displays the game screen that contains the timing UI corresponding to the in-game element set to the character in a case where the action condition for the character selected by the user from the plurality of characters is satisfied; and the executing unit 14D executes the process regarding the character as at least a part of the process corresponding to the evaluation. Therefore, it is possible to provide the user a video game with high interest in which different timing UIs may respectively be associated with the plurality of characters.

### Fifth Embodiment

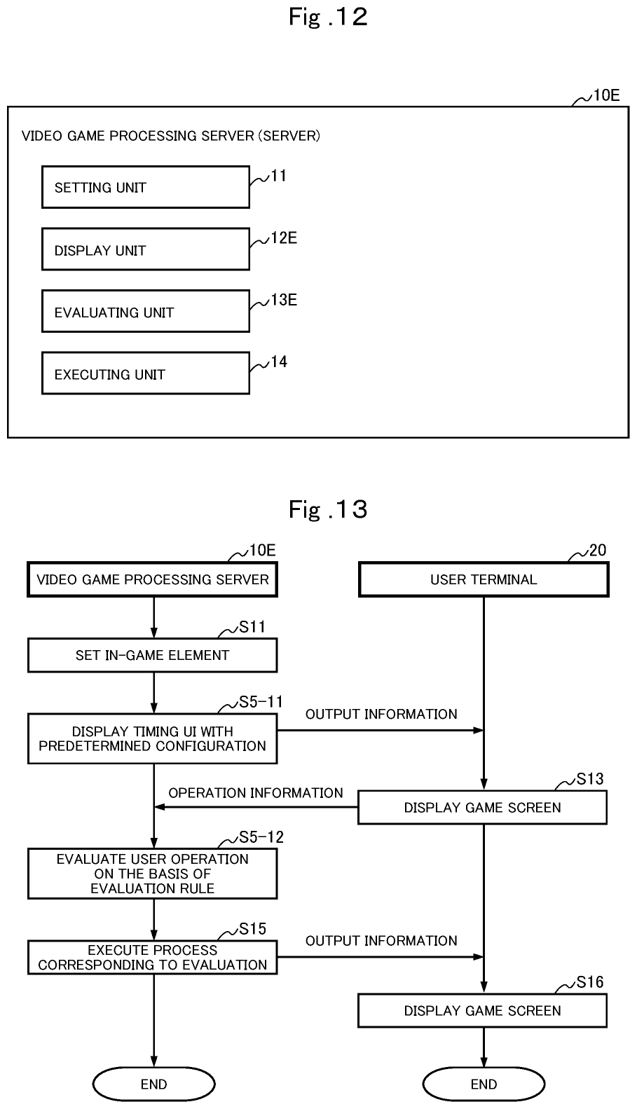

FIG. 12 is a block diagram illustrating a configuration of a video game processing server 10E (hereinafter, referred to as a “server 10E”), which is an example of the video game processing server 10. In the present embodiment, the server 10E at least includes a setting unit 11, a display unit 12E, an evaluating unit 13E, and an executing unit 14.

The display unit 12E has a function to display a timing UI that includes a moving portion, a determination area, and a frequency portion. The moving portion is configured to move in accordance with a lapse of time. The determination area is positioned on a movement path of the moving portion. The frequency portion shows a user the number of times that an action is allowed for the user. A configuration of at least the movement path or the determination area is different between timing UIs whose types are different from each other.

Here, a concrete configuration of the timing UI is not limited particularly. However, it is preferable that it is a configuration in which the user is allowed to recognize that a relationship between the moving portion and the determination area at input timing is evaluated. As an example of such a configuration, there is a configuration in which the moving portion and the determination area are displayed so as to be highlighted compared with other images. Further, the configuration to show the user the number of times that an action is allowed for the user is not limited particularly. It may show the user it explicitly or suggestively.

The evaluating unit 13E has a function to evaluate a user operation on the basis of an evaluation rule regarding a positional relation between the moving portion and the determination area when the user operation via a game screen is received.

Here, the content of the evaluation rule is not limited particularly. However, it is preferable that the content is one in which user operations can be classified into plural kinds of evaluation. As examples of the evaluation rule, there are a rule in which the positional relation between the moving portion and the determination area is associated with the evaluation, and a rule in which a period from a time when the timing UI is displayed to a time when the user operation is received is associated with the evaluation.

FIG. 13 is a flowchart illustrating an example of game processing executed by the system 100. Hereinafter, operations of the server 10E and a terminal 20 will be described as an example. In this regard, description of a flowchart for illustrating an operation of each of the server 10E and the terminal 20 is omitted from a point of view to avoid repeated explanation.

When an in-game element is set, the server 10E displays a timing UI with a predetermined configuration (Step S5-11). In the present embodiment, in a case where an action condition against an operation target is satisfied, the server 10E transmits output information for causing the terminal 20 to display the timing UI corresponding to the in-game element set to the operation target to the terminal 20.

When operation information is received from the terminal 20, the server 10E evaluates a user operation on the basis of an evaluation rule (Step S5-12). In the present embodiment, the server 10E evaluates the user operation on the basis of the evaluation rule corresponding to the timing UI that the terminal 20 is caused to display.

As explained above, as one side of the fifth embodiment, the server 10E is configured so as to include the setting unit 11, the display unit 12E, the evaluating unit 13E, and the executing unit 14. Thus, the display unit 12E displays the timing UI that includes the moving portion, which is configured to move in accordance with a lapse of time, the determination area, which is positioned on the movement path of the moving portion, and the frequency portion, which shows the user the number of times that an action is allowed for the user. In this case, the configuration of at least the movement path or the determination area is different between timing UIs whose types are different from each other; and the evaluating unit 13E evaluates the user operation on the basis of the evaluation rule regarding the positional relation between the moving portion and the determination area when the user operation via the game screen is received. Therefore, it is possible to cause operability of the timing UI, which can change in accordance with the in-game element set to the operation target, to have variations.

### Sixth Embodiment

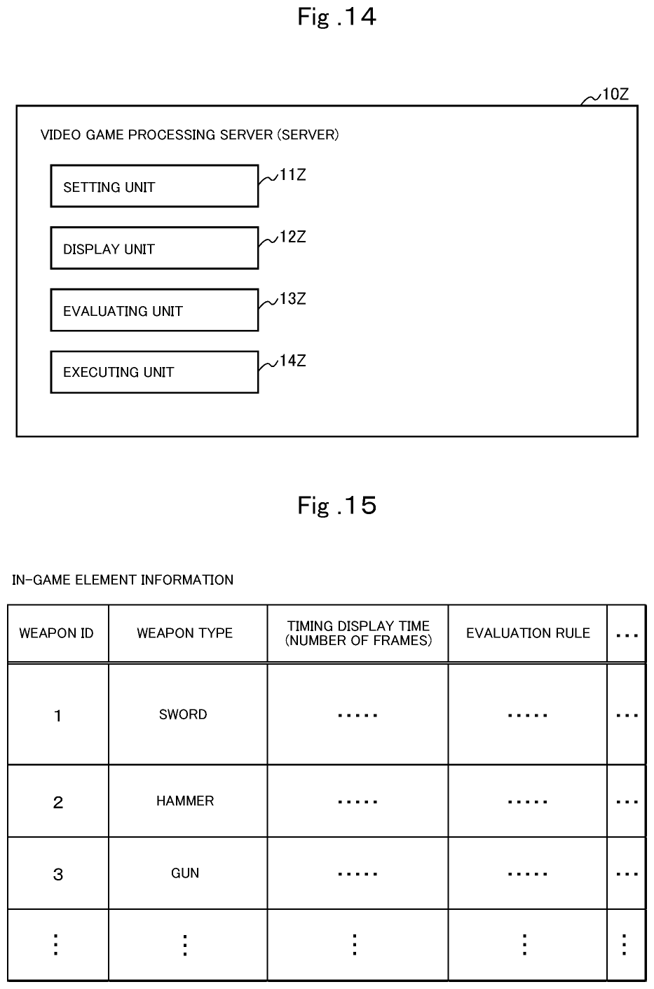

FIG. 14 is a block diagram illustrating a configuration of a video game processing server 10Z (hereinafter, referred to as a “server 10Z”), which is an example of the video game processing server 10 in the system 100 (see FIG. 1). In the present embodiment, the server 10Z at least includes a setting unit 11Z, a display unit 12Z, an evaluating unit 13Z, and an executing unit 14Z. Hereinafter, with respect to the words described above, each of a weapon as an in-game element and a user character as an operation target will be described as an example.

The setting unit 11Z has a function to set a weapon associated with a user interface for evaluating operation timing by a user (that is, a timing UI) to a user character that is an operation target of the user (that is, a player of a video game).

Here, a weapon set to a character is displayed on a battle screen in a state where the character is equipped with the weapon. Further, the timing UI corresponding to the weapon is displayed for receiving a user operation.

FIG. 15 is an explanatory drawing for explaining an example of a storage state of information to be stored in a storage unit (not illustrated in the drawings) included in a server. As illustrated in FIG. 15, the storage unit stores therein a weapon ID, a weapon type, a timing display time, and an evaluation rule so as to be associated with each other.

Here, the weapon ID is a unique ID of a serial number to be set to a weapon.

Further, the weapon type is used to identify any of plural kinds of timing UIs. Hereinafter, a case where the weapon type has three kinds (including a sword, a hammer, and a gun) will be described as an example.

Further, the phrase “timing display time” means a period from start of display of a timing UI to end of the display. A method of setting the timing display time is not limited particularly. However, it is preferable that it may be configured so that a different time can be set in accordance with a weapon. As an example of the method of setting the timing display time, there is a method of setting it by the number of frames.

Further, the word “evaluation rule” means a rule for evaluating a user operation when a timing UI is displayed. The content of the evaluation rule is not limited particularly. However, it is preferable that the evaluation rule is one that allows the user to easily grasp it. As an example of the evaluation rule, there is a rule in which a frame ID of timing that becomes the highest evaluation and the number of frames indicating a range determined as other evaluation (for example, best or good) are defined.

The display unit 12Z has a function to display a game screen, which contains a timing UI corresponding to a weapon during equipment among plural kinds of timing UIs, in a case where an action condition for the user character is satisfied.

Here, the content of the action condition is not limited particularly. However, it is preferable that it is configured so that the user is allowed to recognize the content. Hereinafter, a case where a turn of the user in a so-called turn-based battle and one or more of an action point of the user are an action condition will be described as an example.

The evaluating unit 13Z has a function to evaluate a user operation via the game screen on the basis of the evaluation rule corresponding to the timing UI.

Here, the content of the user operation is not limited particularly. However, it is preferable that it is an operation against a touch panel. Hereinafter, a case where a tap operation against the terminal 20 is evaluated will be described as an example.

The executing unit 14Z has a function to execute a process corresponding to the evaluation.

Here, the content of the process corresponding to the evaluation is not limited particularly. However, it is preferable that an advantageous process for the user is executed as the evaluation is better. Hereinafter, a case where attack power of a character becomes higher as evaluation of a tap operation is higher will be described as an example.

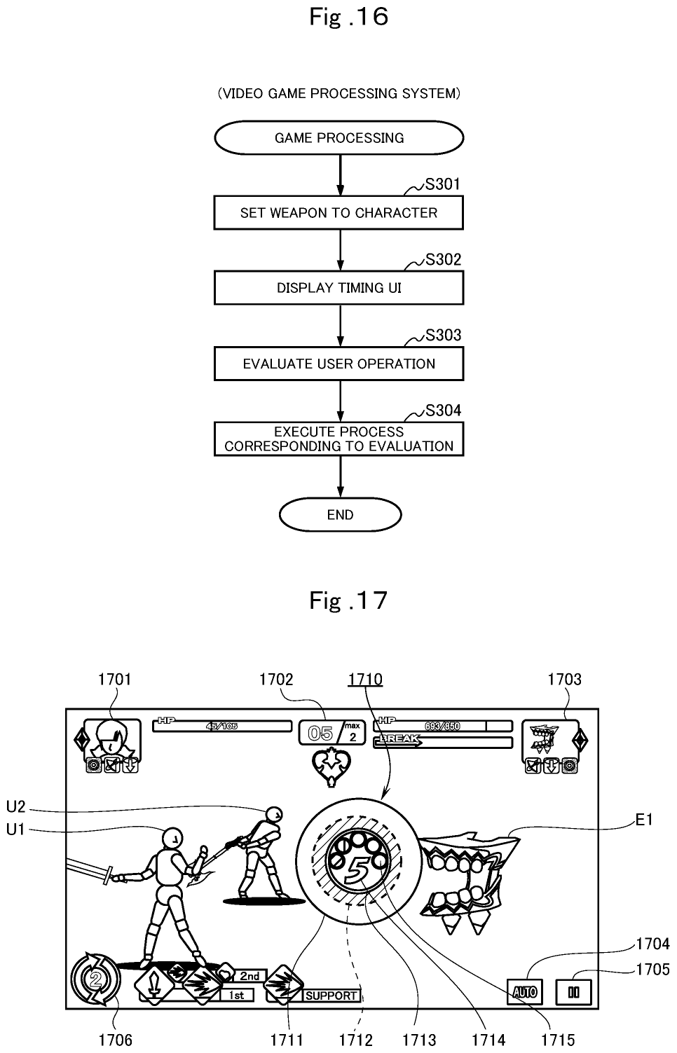

FIG. 16 is a flowchart illustrating an example of game processing executed by a video game processing system 100Z (hereinafter, referred to as a “system 100Z”) that includes the server 10Z. As illustrated in FIG. 16, the system 1002 according to the present embodiment executes a process regarding the timing UI as a process regarding the video game. Hereinafter, each of processes will be described. In this regard, the respective processes may be executed in random order in a range where contradiction or the like does not occur in the content of the processing.

The system 100Z sets a weapon to the character in accordance with progress of the video game (Step S301). In the present embodiment, the system 100Z causes each of two characters to be operated in a battle to be equipped with a weapon specified by the user. In this regard, the equipped weapon is displayed in a state that the character holds it.

When the weapon is set to the character, the system 1002 displays a timing UI (Step S302); evaluate a user operation (Step S303); and executes a process corresponding to the evaluation (Step S304). In the present embodiment, when the tap operation is received in a turn of the user after start of the turn-based battle, the system 100Z displays the timing UI corresponding to equipment of the character that carries out an attack. In this regard, a place to be tapped is not limited particularly. In a case where a place other than positions of buttons each having a dedicated function, such as pause, is tapped, it is determined that this is an operation of a tap attack.

FIG. 17 is an explanatory drawing for explaining an example of the game screen. As illustrated in FIG. 17, the game screen contains an area 1701 in which an icon of the user character is displayed, an area 1702 in which the action point of the user is displayed, an area 1703 in which an icon of an enemy character is displayed, an automatic button 1704, a pause button 1705, a change attack button 1706, and a timing UI 1710.

Here, an icon corresponding to a user character U1 that becomes an operation target of the user and an icon of a user character U2 that does not become an operation target of the user are displayed in the area 1701. Namely, in the present embodiment, when a battle is executed by a party configured by a plurality of user characters, the user sets one user character to a target to be operated by using the timing UI (that is, an operation character). In this regard, user characters other than the operation character participate in the battle as characters each of which may become an operation character by a predetermined operation (that is, members).

Further, the word “action point” (hereinafter, referred to as an “AP”) means a point that is consumed in a case where the user character is caused to act. In the present embodiment, the AP is consumed by one whenever the tap attack is carried out once. The user is allowed to continue the attack until the AP becomes zero. When the AP becomes zero, a final attack is generated, the own turn is ended. Further, in a case where a tap is carried out during a stand-by state, display of the timing UI is started, but any attack is not generated. Since this tap is not an attack, consumption of the AP is not generated. However, it may be configured so that a first attack is executed in response to a first tap and the timing UI is displayed from a next tap.

Further, the automatic button 1704 is a virtual button for trusting progress of the battle to a computer. The user is allowed to trust progress of the battle to the computer by tapping the automatic button 1704. However, in this case, an operation in which only an attack against a main character is executed until the AP runs out is executed, and all their timing becomes the fastest input (that is, an input equivalent to successive pressing). Namely, the attack is executed, but evaluation of the operation is not executed (or predetermined evaluation is made). Further, the timing UI and timing evaluation are not displayed while an automatic operation is turned ON.

Further, the pause button 1705 is a virtual button for temporarily stopping progress of the video game or progress of the battle.

Further, the change attack button 1706 is a virtual button for executing a change attack. Here, the word “change attack” means an action that is executed when the member becomes an operation character. Any other member becomes an operation character after the change attack. At this time, the user character that has been the operation character until that time becomes a member. More specifically, in a case where both the members and the operation character are not present at an initial position (that is, a weapon position), the member carries out an attack while moving to a position determined for each type of weapon, and the existing operation character moves to arrangement of the member (that is, a member position). Further, in a case where the operation character is present at the weapon position, the member carries out the attack while moving to the position determined for each type of weapon, and the operation character moves to the member position after reproduction of attack motion is terminated. In this regard, the number of hits of the change attack is calculated on the basis of the type of weapon set to the member. Further, the change attacks can be kept in stock up to three times in the number of times basis, and the number of times of the change attack is recovered by one at the time of start of the own turn. Moreover, the AP is not consumed at the time of usage of the change attack. Further, in a case where it is during a combo, the combo continues (the change attack is counted as BEST determination). Namely, the system 1002 executes certain evaluation in a case where the operation target is changed in response to the user operation to change the operation target.

Further, the timing UI 1710 is a UI that is displayed when timing determination is executed. The timing determination is generated while an input of a tap attack is received. Namely, the system 100Z displays a timing UI corresponding to the weapon with which the operation character is equipped while the timing determination is being generated. When a tap attack is executed while the timing UI is displayed, any evaluation of three kinds of evaluation including BEST (the best evaluation in which “BEST” is displayed), GOOD (good evaluation in which “GOOD” is displayed), and BAD (bad evaluation in which “BAD” is displayed) can be acquired. When the evaluation “BEST” or “GOOD” is acquired, damage and the number of hits are increased compared with an attack of “BAD”. Further, when the evaluation “BEST” or “GOOD” is acquired, the combo can continue. In this regard, the timing determination is executed on the basis of the number of frames that is separately set for each weapon. Hereinafter, the timing UI will be described.

In the present embodiment, the timing UI has common appearance with respect to the weapon type (the sword, the hammer, and the gun), but its operation is different from each other. Further, as a display position of the timing UI, the timing UI is displayed at a common position with respect to all weapon types regardless of a size of an enemy character. This makes it possible to reduce a possibility that the user leads to misunderstanding that a tap has to be carried out by aiming at a position of the UI. In this regard, the display of the timing UI is started after a dash or after hit of the change attack in addition to a case where the tap attack is evaluated. Then, the display is terminated at the same time when a predetermined action is carried out (for example, display of the marker for the final attack is terminated, interruption of a consecutive attack due to leaving, or the change attack). However, the display continues while the change is not carried out and the consecutive attack is established.

FIG. 17 is an example of the game screen in which the timing UI 1710 for the sword is displayed in accordance with a sword type of weapon with which an operation character U1 is equipped. The timing UI 1710 for the sword includes a marker 1711, a GOOD area 1712, a BEST line 1713, remaining attack frequency display 1714, and lamps 1715.

The marker 1711 appears outside the timing UI, and is a circular UI that is converging. Display of the marker 1711 is started with the largest size at the time of start of display of the timing UI, and the marker 1711 becomes the smallest size at the time of end of the display of the timing UI. When an input of a tap attack (a tap to any place other than positions of a group of buttons) is generated while converging, the marker 1711 disappears after shining, and the timing determination is executed. Positions of a starting point and an ending point of the marker 1711 are always fixed, and do not change. A movement speed of the marker 1711 changes on the basis of a parameter set to the weapon.

The GOOD area 1712 is a circle indicating a determination area in which evaluation of GOOD or higher can be obtained. By carrying out a tap attack when the marker is present within the GOOD area 1712, continuation of the combo is assured. An area for BEST determination is included within the GOOD area 1712. In this regard, since a GOOD range changes in each attack, the GOOD area 1712 is redisplayed whenever a tap attack is executed.

The BEST line 1713 is a line indicating input timing that becomes a correct answer.

The remaining attack frequency display 1714 is display for informing the user of the number of times of remaining attacks that is calculated on the basis of an AP that is consumed when the operation character acts and a current AP of the user.

The lamps 1715 are used to count an extra attack point. Here, the word “extra attack” means an attack that is generated with camera representation in a case where a condition is achieved at timing when a final AP of the own turn is consumed. In the present embodiment, execution of a termination attack in a state where an internal parameter “extra attack point” exceeds ten times of an upper limit of the AP is provided as a condition to generate an extra attack. Further, the extra attack point is a parameter used to determine generation of the extra attack, and increases by achieving BEST of the timing determination or achieving GOOD of the timing determination. Namely, in a case where an accumulation state of evaluation of the user operation satisfies a condition, the extra attack is executed as a process different from an influence on the tap attack. In this regard, in the present embodiment, accumulation of the extra attack point is executed during continuation of the combo. When the combo is interrupted, the accumulation returns to 0 (zero) point. Namely, in a case where the evaluation of the user operation continues at a constant level, the system 1002 generates an effect that the user may enjoy an advantage in the video game.

With respect to whether to approach achievement of an extra attack condition or not, it is indicated by the lamps positioned at a central portion of the timing UI. In the present embodiment, five lamps each of which shines with two steps of brightness are prepared, and a level of storage or accumulation of the extra attack point is announced by 10% to 10%. Namely, the system 100Z accumulates evaluation of the user operation as the extra attack point. In a case where this accumulation state satisfies a predetermined condition, the system 100Z executes a process corresponding to the predetermined condition. Further, the system 100Z causes the evaluation of the user operation to influence on appearance of the timing UI.

A dedicated “effect at the time of hit” exists in the extra attack. It is preferable that the dedicated effect is set to a direction to develop a feature of each type of weapon. As an example of such a configuration, there is a configuration to adjust an attack motion parameter. Namely, for example, it may be configured so that an HP damage is heightened in a case of the sword; a faint (piyori) damage is heightened in a case of the hammer; and a recovery amount of a skill point is heightened in a case of the gun.

In a case where the operation character is equipped with a sword type of weapon, the timing UI that has been described with reference to FIG. 17 is used, and an attack by the sword (that is, a sword attack) is caused to proceed by the following flow. First, when a tap is carried out during a stand-by state of the operation character, the system 100Z starts to reproduce attack preparing motion of the sword attack, and displays the timing UI thereof. Then, the system 100Z starts to reproduce attack motion of a first sword attack when a tap is carried out while the timing UI is displayed; starts to reproduce attack motion of a second sword attack when a tap is further carried out while the timing UI is displayed; starts to reproduce attack motion of a third sword attack when a tap is further carried out while the timing UI is displayed; starts to reproduce attack motion of a fourth sword attack when a tap is further carried out while the timing UI is displayed; starts to reproduce attack motion of the second sword attack when a tap is further carried out while the timing UI is displayed (loop); and continuously starts to reproduce an extra attack in a case where the condition is satisfied after the attack by which the AP runs out. In this regard, in a case where it becomes a state that a tap is carried out during the attack motion for the second to fourth attack and the AP runs out in a next attack thereof, the next attack is exchanged by a final attack. Further, an input into the timing UI for the sword attack is possible only once. In a case where the input is carried out, the next attack is started at the same time of the input. Then, when the display of the timing UI is terminated without any tap input, the attack does not shift to a next attack, and the operation character is caused to return to a fixed position.

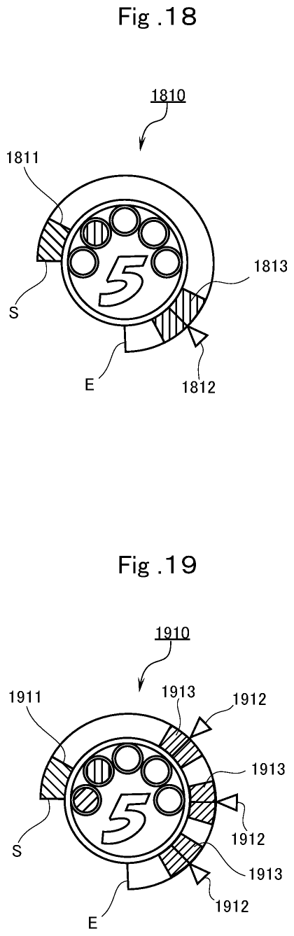

FIG. 18 is an explanatory drawing for explaining another example of the timing UI. Here, a timing UI corresponding to a hammer type of weapon will be described. A timing UI 1810 for the hammer includes a gauge 1811, a BEST line 1812, and a GOOD area 1813.

The gauge 1811 is a UI that stretches and proceeds in a clockwise manner around the circumference of the timing UI while a holding operation is carried out. At the time of start of display of the timing UI, the gauge 1811 starts to stretch from a starting point S positioned at a left side in a clockwise manner, and at the time of end of the display of the timing UI, the gauge 1811 reaches an ending point E positioned at a lower side. In a case where the user causes his or her finger to separate from a touch panel while the gauge 1811 is stretching, the gauge 1811 shines and then disappears, and timing determination is executed. Namely, for example, when the user causes his or her finger to separate from the touch panel at a place where a tip of the gauge 1811 overlaps the BEST line 1812, the BEST determination is succeeded. In a case where the user does not cause the finger to separate from the touch panel until the tip of the gauge 1811 reaches a terminal thereof, an attack by BAD determination is forcibly executed. Positions of a starting point and an ending point of the gauge 1811 are always fixed, and do not change. A speed of stretch of the gauge 1811 changes on the basis of a parameter set to the weapon.

In a case where the operation character is equipped with a hammer type of weapon, the timing UI that has been described with reference to FIG. 18 is used, and an attack by the hammer (that is, a hammer attack) is caused to proceed by the following flow. First, when a holding operation is started during a stand-by state of the operation character, the system 100Z starts to reproduce attack preparing motion of the hammer attack, and displays the timing UI thereof. Then, the system 100Z starts to reproduce attack motion of a first hammer attack when the holding operation is ended while the timing UI is displayed; starts to reproduce attack motion of a second hammer attack when the holding operation is started and then ended while the timing UI is displayed; starts to reproduce attack motion of a third hammer attack when the holding operation is further started and then ended while the timing UI is displayed; starts to reproduce attack motion of a fourth hammer attack when the holding operation is further started and then ended while the timing UI is displayed; starts to reproduce attack motion of the second hammer attack when the holding operation is started and then ended while the timing UI is displayed (loop); and continuously starts to reproduce an extra attack in a case where the condition is satisfied after the attack by which the AP runs out. In this regard, an input into the timing UI for the hammer is possible by causing the finger to separate from the touch panel after long pressing. It is determined that the input is made at the time of separation even though a pressing time is instantaneous. Further, damage does not change due to a length of the pressing time. Only a change in the damage by sweet spot determination (in the present embodiment, BEST or GOOD) is generated. When the display of the timing UI is terminated during the holding operation, the attack does not shift to a next attack, and the operation character is caused to return to a fixed position.

FIG. 19 is an explanatory drawing for explaining still another example of the timing UI. Here, a timing UI corresponding to a gun type of weapon will be described. A timing UI 1910 for the gun includes a gauge 1911, and a plurality of combinations of a BEST line 1912 and a GOOD area 1913.

The gauge 1911 is a UI that stretches and proceeds in a clockwise manner around the circumference of the timing UI. At the time of start of display of the timing UI, the gauge 1911 starts to stretch from a starting point S, and stretches at a speed to reach an ending point E at the time of end of the display of the timing UI. When an input of a tap attack (a tap any place other than positions of a group of buttons) is generated while the gauge 1911 is stretching, the gauge 1911 shines and then disappears, and timing determination is executed. Namely, for example, when the user carries out a tap operation at a place where a tip of the gauge 1911 overlaps the BEST line 1912, the BEST determination is succeeded. In a case where the user does not carryout any tap operation until the tip of the gauge 1911 reaches a terminal thereof, an attack by BAD determination is forcibly executed. Further, the system 100Z starts to display the BEST line 1912 for the gun at the same time of the start of the display of the gauge 1911, and cause the BEST lines 1912 to disappear one by one from the earlier timing whenever the tap is carried out. In a case where any BEST line remains at the time of the end of the display of the gauge 1911, the display of all remaining BEST lines 1912 is cancelled at the same time of the end of the display of the gauge 1911. This is because timing of BEST may change for each attack. Moreover, in the displaying BEST lines 1912, only one BEST line at the earliest timing is brightly displayed, and the other BEST lines are darkly displayed by one step. Positions of a starting point and an ending point of the gauge 1911 are always fixed, and do not change. A speed of stretch of the gauge 1911 changes on the basis of a parameter set to the weapon.

In a case where the operation character is equipped with a gun type of weapon, the timing UI that has been described with reference to FIG. 19 is used, and an attack by the gun (that is a gun attack) is caused to proceed by the following flow. First, when a tap is carried out during a stand-by state of the operation character, the system 100Z starts to reproduce attack preparing motion of the gun attack, and displays the timing UI thereof. Then, the system 100Z starts to reproduce attack motion of a first gun attack when a tap is carried out even once while the timing UI is displayed; starts to reproduce attack motion of a second gun attack when a tap is further carried out while the timing UI is displayed; starts to reproduce attack motion of a third gun attack when a tap is further carried out while the timing UI is displayed; starts to reproduce attack motion of a fourth gun attack when a tap is further carried out while the timing UI is displayed; starts to reproduce attack motion of the second gun attack when a tap is further carried out while the timing UI is displayed (loop); and continuously starts to reproduce an extra attack in a case where the condition is satisfied after the attack by which the AP runs out. In this regard, an input into the timing UI for the gun attack is possible up to the number of times set for one step, and the number of times that an input is allowed is set to any one of between one to five for each weapon or each step number of an attack. Further, an attack is reproduced whenever an input is carried out. When attacks of the number of times thus set are generated or the display of the timing UI is terminated, the attack is caused to proceed to a next attack (also proceed in a case where attacks of less than the number of times thus set are executed). Then, in a case where any tap is not made until the display of the timing UI is terminated, the attack does not shift to a next attack, and the operation character is caused to return to a fixed position.

As explained above, as one side of the sixth embodiment, the video game processing server 10Z provided with the functions to control progress of the video game in response to an operation of the user is configured so as to include the setting unit 11Z, the display unit 12Z, the evaluating unit 13Z, and the executing unit 14Z. Thus, the setting unit 11Z sets the in-game element (for example, equipment), which is associated with the user interface for evaluating the operation timing by the user (the timing UI), to the operation target of the user (for example, the user character); the display unit 12Z displays the game screen, which contains the timing UI corresponding to the set in-game element among the plural kinds of timing UIs, on the display screen of the terminal in a case where the action condition for the operation target is satisfied; the evaluating unit 13Z evaluates the user operation via the game screen on the basis of the evaluation rule corresponding to the timing UI; and the executing unit 14Z executes the process corresponding to the evaluation. Therefore, it is possible to cause a method of using the in-game element to have variations to improve interest in the video game.

Further, in the example of the sixth embodiment described above, the server 10Z is configured to execute certain evaluation (for example, the change attack that is counted as BEST determination) in a case where the operation target is changed in response to the user operation to change the operation target. Therefore, it is possible to cause progress of the video game to have variations further.

Further, in the example of the sixth embodiment described above, the server 10Z is configured to generate the effect that the user enjoys an advantage in the video game (for example, accumulation of the extra attack point that is executed during continuation of the combo) in a case where the evaluation continues at the constant level. Therefore, it is possible to cause progress of the video game to have variations further.

As explained above, one or two or more shortages can be solved by each of the embodiments of the present application. In this regard, the effects according to each of the embodiments are non-limiting effects or one example of the non-limiting effects.

In this regard, in each of the embodiments described above, each of the plurality of user terminals 20 and 201 to 20N and the server 10 carries out the various kinds of processing described above in accordance with various kinds of control programs (for example, a video game processing program) stored in the storage device with which the corresponding terminal or server is provided.

Further, a configuration of the system 100 is limited to the configuration that has been explained as an example of each of the embodiments described above. For example, the system 100 may be configured so that part or all of the processing that has been explained as the processing carried out by the user terminal is carried out by the server 10, or it may be configured so that part or all of the processing that has been explained as the processing carried out by the server 10 is carried out by any of the plurality of user terminals 20 and 201 to 20N (for example, the user terminal 20). Further, the system 100 may be configured so that a part or all of the storing sections included by the server 10 is included in any of the plurality of user terminals 20 and 201 to 20N. Namely, the system 100 may be configured so that a part or all of the functions included in any one of the user terminal 20 and the server 10 according to the system 100 is included in the other.

Further, the program may be configured so as to cause a single apparatus that does not include a communication network to realize a part or all of the functions that have been explained as the examples of the respective embodiments described above.

### APPENDIX

The explanation of the embodiments described above has been described so that the following inventions can be at least realized by a person having a normal skill in the art to which the present invention belongs.

(1)

A video game processing program for causing a server to realize functions to control progress of a video game in response to an operation of a user,

wherein the functions include:

a setting function configured to set an in-game element to an operation target of the user, a user interface for evaluating operation timing by the user (hereinafter, referred to as a “timing UI”) being associated with the in-game element;

a display function configured to cause a terminal to display a game screen on a display screen of the terminal in a case where an action condition for the operation target is satisfied, the game screen containing the timing UI corresponding to the set in-game element among plural kinds of timing UIs;

an evaluating function configured to evaluate a user operation via the game screen on a basis of an evaluation rule corresponding to the timing UI; and

an executing function configured to execute a process corresponding to the evaluation.

(2)

The video game processing program according to (1),

wherein the functions further include:

an accumulate function configured to accumulate the evaluation by the evaluating function, and

wherein the executing function includes a function configured to execute, in a case where an accumulation state of the evaluation satisfies a predetermined condition, a process corresponding to the predetermined condition in addition to the process corresponding to the evaluation.

(3)

The video game processing program according to (1) or (2),

wherein the functions further include:

a determining function configured to determine whether an action against the operation target is allowed repeatedly in a same turn or not on a basis of a predetermined determination rule in a case where the user operation is evaluated in a turn-based battle using the operation target, and

wherein the display function includes a function configured to display a timing UI to which at least preceding evaluation is reflected in a case where it is determined, by the determining function, that the action is allowed.

(3-1)

The video game processing program according to (3),

wherein the executing function includes a function configured to execute the predetermined process before termination in one turn in a case where evaluation of the user operation corresponding to the operation target satisfies the predetermined condition by a predetermined number of times in the one turn.

(4)

The video game processing program according to any one of (1) to (3),

wherein the setting function includes a function configured to set an in-game element to each of a plurality of characters as the operation target of the user,

wherein the display function includes a function configured to display a game screen in a case where an action condition for a character selected from the plurality of characters by the user is satisfied, the game screen containing a timing UI corresponding to an in-game element set to the selected character, and

wherein the executing function includes a function configured to execute a process regarding the selected character as at least a part of the process corresponding to the evaluation.

(5)

The video game processing program according to any one of (1) to (4),

wherein the display function includes a function configured to display a timing UI that includes a moving portion, a determination area, and a frequency portion, the moving portion moving in accordance with a lapse of time, the determination area being positioned on a movement path of the moving portion, the frequency portion showing the user a number of times that an action is allowed, a configuration of at least the movement path or the determination area being different between timing UIs whose types are different from each other, and

wherein the evaluating function includes a function configured to evaluate the user operation on the basis of the evaluation rule regarding a positional relation between the moving portion and the determination area when a user operation via the game screen is received.

(6)

The video game processing program according to any one of (1) to (5),

wherein the functions further include:

a changing function configured to change the operation target in response to the user operation, and

wherein the evaluating function includes a function configured to execute a certain evaluation in a case where the operation target is changed by the changing function.

(7)

The video game processing program according to any one of (1) to (6),

wherein the functions further include:

a generating function configured to generate an effect that the user enjoys an advantage in the video game in a case where the evaluation by the evaluating function continues at a constant level.

(8)

A program for processing a video game, the program causing a user terminal to realize at least one function of the functions that the video game processing program according to any one of (1) to (7) cause the server to realize, the user terminal being capable of communicating with the server.

(9)

A server into which the video game processing program according to any one of (1) to (8) is installed.

(10)

A video game processing system including a communication network, a server, and a user terminal, the video game processing system configured to control progress of a video game in response to an operation of a user, the video game processing system comprising:

a setting unit configured to set an in-game element to an operation target of the user, a user interface for evaluating operation timing by the user (hereinafter, referred to as a “timing UI”) being associated with the in-game element;

a display unit configured to cause a terminal to display a game screen on a display screen of the terminal in a case where an action condition for the operation target is satisfied, the game screen containing the timing UI corresponding to the set in-game element among plural kinds of timing UIs;

an evaluating unit configured to evaluate a user operation via the game screen on a basis of an evaluation rule corresponding to the timing UI; and

an executing unit configured to execute a process corresponding to the evaluation.

(11)

The video game processing system according to (10),

wherein the server includes the setting unit, the display unit, the evaluating unit, and the executing unit, and

wherein the user terminal includes an outputting unit configured to output a game screen to a display screen of a display device, the game screen indicating an execution result of the process corresponding to the evaluation by the executing unit.

(12)

A video game processing program for causing a user terminal to realize functions to control progress of a video game in response to an operation of a user,

wherein the functions include:

a function configured to receive information regarding any of functions with which a server is provided; and a function configured to execute input and output corresponding to the function, and

wherein the functions of the server include:

a setting function configured to set an in-game element to an operation target of the user, a user interface for evaluating operation timing by the user (hereinafter, referred to as a “timing UI”) being associated with the in-game element;

a display function configured to cause a terminal to display a game screen on a display screen of the terminal in a case where an action condition for the operation target is satisfied, the game screen containing the timing UI corresponding to the set in-game element among plural kinds of timing UIs;

an evaluating function configured to evaluate a user operation via the game screen on a basis of an evaluation rule corresponding to the timing UI; and an executing function configured to execute a process corresponding to the evaluation.

(13)

A video game processing program for causing a user terminal to realize functions to control progress of a video game in response to an operation of a user,

wherein the functions include:

a setting function configured to set an in-game element to an operation target of the user, a user interface for evaluating operation timing by the user (hereinafter, referred to as a “timing UI”) being associated with the in-game element;

a display function configured to cause the user terminal to display a game screen in a case where an action condition for the operation target is satisfied, the game screen containing the timing UI corresponding to the set in-game element among plural kinds of timing UIs;

an evaluating function configured to evaluate a user operation via the game screen on a basis of an evaluation rule corresponding to the timing UI; and

an executing function configured to execute a process corresponding to the evaluation.

(14)

A video game processing program for causing a server to realize at least one function of the functions that the video game processing program according to (13) causes the user terminal to realize, the server being capable of communicating with the user terminal.

(15)

A user terminal into which the video game processing program according to (12) or [13) is installed.

(16)

A video game processing method of controlling progress of a video game in response to an operation of a user, the video game processing method comprising:

a setting process configured to set an in-game element to an operation target of the user, a user interface for evaluating operation timing by the user (hereinafter, referred to as a “timing UI”) being associated with the in-game element;

a display process configured to cause a terminal to display a game screen on a display screen of the terminal in a case where an action condition for the operation target is satisfied, the game screen containing the timing UI corresponding to the set in-game element among plural kinds of timing UIs;

an evaluating process configured to evaluate a user operation via the game screen on a basis of an evaluation rule corresponding to the timing UI; and

an executing process configured to execute a process corresponding to the evaluation.

(17)

A video game processing method executed by a video game processing system to control progress of a video game in response to an operation of a user, the video game processing system comprising a communication network, a server, and a user terminal, the video game processing method comprising:

a setting process configured to set an in-game element to an operation target of the user, a user interface for evaluating operation timing by the user (hereinafter, referred to as a “timing UI”) being associated with the in-game element;

a display process configured to cause a terminal to display a game screen on a display screen of the terminal in a case where an action condition for the operation target is satisfied, the game screen containing the timing UI corresponding to the set in-game element among plural kinds of timing UIs;

an evaluating process configured to evaluate a user operation via the game screen on a basis of an evaluation rule corresponding to the timing UI; and

an executing process configured to execute a process corresponding to the evaluation.

### INDUSTRIAL APPLICABILITY

According to one of the embodiments of the present invention, it is useful to cause a method of using an in-game element to have variations to improve interest in a video game.

### EXPLANATION OF REFERENCE NUMERALS

10 server
20, 201 to 20N user terminal
11 setting unit
12 display unit
13 evaluating unit
14 executing unit
15 accumulating unit
16 determining unit
30 communication network
100 system

1. A video game processing program for causing a server to realize functions to control progress of a video game in response to an operation of a user,
wherein the functions include:
a setting function configured to set an in-game element to an operation target of the user, a user interface for evaluating operation timing by the user (hereinafter, referred to as a “timing UI”) being associated with the in-game element;
a display function configured to cause a terminal to display a game screen on a display screen of the terminal in a case where an action condition for the operation target is satisfied, the game screen containing the timing UI corresponding to the set in-game element among plural kinds of timing UIs;
an evaluating function configured to evaluate a user operation via the game screen on a basis of an evaluation rule corresponding to the timing UI; and
an executing function configured to execute a process corresponding to the evaluation.

2. The video game processing program according to claim 1,
wherein the functions further include:
an accumulate function configured to accumulate the evaluation by the evaluating function, and
wherein the executing function includes a function configured to execute, in a case where an accumulation state of the evaluation satisfies a predetermined condition, a process corresponding to the predetermined condition in addition to the process corresponding to the evaluation.

3. The video game processing program according to claim 1,
wherein the functions further include:
a determining function configured to determine whether an action against the operation target is allowed repeatedly in a same turn or not on a basis of a predetermined determination rule in a case where the user operation is evaluated in a turn-based battle using the operation target, and
wherein the display function includes a function configured to display a timing UI to which at least preceding evaluation is reflected in a case where it is determined, by the determining function, that the action is allowed.

4. The video game processing program according to claim 1,
wherein the setting function includes a function configured to set an in-game element to each of a plurality of characters as the operation target of the user,
wherein the display function includes a function configured to display a game screen in a case where an action condition for a character selected from the plurality of characters by the user is satisfied, the game screen containing a timing UI corresponding to an in-game element set to the selected character, and
wherein the executing function includes a function configured to execute a process regarding the selected character as at least a part of the process corresponding to the evaluation.

5. The video game processing program according to claim 1,
wherein the display function includes a function configured to display a timing UI that includes a moving portion, a determination area, and a frequency portion, the moving portion moving in accordance with a lapse of time, the determination area being positioned on a movement path of the moving portion, the frequency portion showing the user a number of times that an action is allowed, a configuration of at least the movement path or the determination area being different between timing UIs whose types are different from each other, and
wherein the evaluating function includes a function configured to evaluate the user operation on the basis of the evaluation rule regarding a positional relation between the moving portion and the determination area when a user operation via the game screen is received.

6. A video game processing system including a communication network, a server, and a user terminal, the video game processing system configured to control progress of a video game in response to an operation of a user, the video game processing system comprising:
a setting unit configured to set an in-game element to an operation target of the user, a user interface for evaluating operation timing by the user (hereinafter, referred to as a “timing UI”) being associated with the in-game element;
a display unit configured to cause a terminal to display a game screen on a display screen of the terminal in a case where an action condition for the operation target is satisfied, the game screen containing the timing UI corresponding to the set in-game element among plural kinds of timing UIs;
an evaluating unit configured to evaluate a user operation via the game screen on a basis of an evaluation rule corresponding to the timing UI; and
an executing unit configured to execute a process corresponding to the evaluation.

7. A video game processing program for causing a user terminal to realize functions to control progress of a video game in response to an operation of a user,
wherein the functions include:
a setting function configured to set an in-game element to an operation target of the user, a user interface for evaluating operation timing by the user (hereinafter, referred to as a “timing UI”) being associated with the in-game element;
a display function configured to cause the user terminal to display a game screen in a case where an action condition for the operation target is satisfied, the game screen containing the timing UI corresponding to the set in-game element among plural kinds of timing UIs;
an evaluating function configured to evaluate a user operation via the game screen on a basis of an evaluation rule corresponding to the timing UI; and
an executing function configured to execute a process corresponding to the evaluation.
